(19) United States
(12) Patent Application Publication
(10) Pub. No.: US 2015/0235126 A1
(43) Pub. Date: Aug. 20, 2015

(54) CONCURRENT EVALUATION OF LARGE RULE SETS WITH CONDITIONS

(71) Applicant: F5 Networks, Inc., Seattle, WA (US)

(72) Inventor: Jeroen Peter de Borst, Sammamish, WA (US)

(21) Appl. No.: 14/624,358

(22) Filed: Feb. 17, 2015

Related U.S. Application Data
(60) Provisional application No. 61/941,357, filed on Feb. 18, 2014.

(51) Int. Cl. G06N 5/02; G06F 17/30

(52) U.S. Cl. CPC G06N 5/022; G06F 17/30864

(57) ABSTRACT

Embodiments are directed towards concurrent evaluation of large rule sets with conditions. A rule compiler may receive rule sets that include rules for policy management. During compilation, root nodes may be generated that include the rules and set to the current node in during the building of a decision tree. Next, the most common operand and a condition from the rule set may be determined. Evaluators corresponding to the most common operand and its condition may be generated. Each evaluator may include transition points pointing to other nodes in the decision tree. If two or more rules remain a node, the rule compiler may generate another node to process the two or more rules. If a transition corresponds to a single rule absent any condition, the rule compiler generates a match node. Completed decisions trees are deployed for execution in a policy engine.

### RELATED APPLICATIONS

This application is a Utility patent application based on a previously filed U.S. Provisional Patent Application U.S. Ser. No. 61/941,357 filed on Feb. 18, 2014, entitled “CONCURRENT EVALUATION OF LARGE RULE SETS WITH CONDITIONS,” the benefit of the filing date of which is hereby claimed under 35 U.S.C. §119(e), and which is further incorporated by reference in its entirety.

### TECHNICAL FIELD

The present invention relates generally to packet traffic management and, more particularly, but not exclusively to evaluating rules sets used for packet traffic management.

### BACKGROUND

The increasing use of Internet based services has led to a rapid increase in the number of communication connections between client computers and server computers. Traffic management devices such as load balancers, firewalls, switches, or the like, may often be used to manage and process network traffic and network connection between and among the client and server computers. In some applications there may be thousands or millions of client and server connections that need to be managed by network traffic management devices. Often, a client computer establishes a network connection with a server computer by using well-known network protocols, such as Transmission Control Protocol/Internet Protocol (“TCP/IP”), User Datagram Protocol (“UDP”), or the like. Such well-known network protocols often have standard multi-step handshaking processes for establishing connections, exchanging data, and closing connections, and the like. Additionally, the expansion of the Internet has led to improvements in packet traffic management. One such advancement is the use of policy rules for determining how packet traffic may be managed. However, as packet traffic and network applications have increased in volume and complexity, effective and efficient policy rules have also become more difficult to define and manage. Thus, it is with respect to these considerations and others that the invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. For a better understanding of the present invention, reference will be made to the following Detailed Description, which is to be read in association with the accompanying drawings, wherein:

FIG. 1 is a system diagram of an environment in which embodiments of the invention may be implemented;

FIG. 2 shows an embodiment of a client computer that may be included in a system such as that shown in FIG. 1;

FIG. 3 shows an embodiment of a network computer that may be included in a system such as that shown in FIG. 1;

FIG. 4 illustrates a portion of a logical architecture for concurrent evaluation of large rule sets with conditions in accordance with at least one of the embodiments;

FIG. 5 illustrates a table that includes illustrative policy rules in accordance with at least one of the various embodiments;

FIG. 6 shows an illustrative example of an evaluator for evaluating a condition in a rule set in accordance with at least one of the various embodiments;

FIGS. 7A-7C illustrate compilation steps for generating a decision tree for a portion of a rule set in accordance with at least one of the various embodiments;

FIG. 7D illustrates in tabular form the decision tree generated in FIGS. 7A-7C, in accordance with at least one of the various embodiments;

FIG. 8 shows a flowchart of a process for concurrent evaluation of rule sets in accordance with at least one of the embodiments;

FIG. 9 show a flowchart for a process for compiling a decision tree from a rule set in accordance with at least one of the various embodiments;

FIG. 10 shows a flowchart for a process for compiling portions of a rule set in accordance with at least one of the various embodiments; and

FIG. 11 shows a flowchart for a process for the execution concurrent operand evaluations in accordance with at least one of the various embodiments.

### DETAILED DESCRIPTION

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “tuple” refers to a set of values that identify a source and destination of a connection. In one embodiment, a 5 tuple may include a source Internet Protocol (IP) address, a destination IP address, a source port number, a destination port number, VLAN identifier, tunnel identifier, routing interface identifier, physical interface identifier, or a protocol identifier. In at least one of the various embodiments, source port numbers may be a TCP source port number. Likewise, in at least one of the various embodiments, destination port number may be a TCP destination port number. In at least one of the various embodiments, tuples may be used to identify network flows (e.g., connection flows). However, a tuple need not be a 5 tuple, and other combinations of the above may also be used. For example, a tuple may be a four-tuple, using a source IP address, a destination IP address, a source port number, and a destination port number. Other combinations are also considered. Moreover, as used herein, a “flow key” refers to a tuple comprising any combination of fields selected from within a network packet header, including those fields identified above.

As used herein, the terms “network flow,” “connection flow,”, “flow” refer to a network session that may be established between two endpoints. In at least one of the various embodiments, a tuple may describe the flow. In at least one of the various embodiments, flows may be useful if one or more of the endpoint of a network connection may be behind a traffic management device, such as a firewall, switch, load balancer, or the like. In at least one of the various embodiments, such network flows may be used to ensure that the network packets sent between the endpoints of a flow may be routed appropriately. In at least one of the various embodiments, the performance of connection oriented network protocols such as TCP/IP may impaired if network packets may be routed to unexpected endpoints.

As used herein the term “condition” refers to an expression of one or more simple and/or complex conditions related to the information being monitored or managed by an application. For networking applications, conditions may be conditional expressions related to the network traffic passing through a traffic management device. For example, if the web client is an unsupported web browser and is NOT on the admin network or the request URL starts with /video and the client is a mobile device and the client subnet does not match 172.27.56.0/24. Conditions may be arranged into compound conditions that include a logical expression of atomic/simple conditions or compound expressions. In at least one of the various embodiments, conditions may include string pattern matches, such as, starts-with, ends-with, includes, or the like. In addition, other pattern matching methods, such as, regular expressions, may be used as and/or in condition expressions.

As used herein the term “action” refers to an operation is performed by the traffic management device if a rule is matched. Thus, the conditions for a rule guards whether the rule's corresponding action may be executed. In at least one of the various embodiments, actions may be simple or complex. Also, actions may comprise built-in functions and values or customized scripts, or a combination thereof. In at least one of the various embodiments, for networking applications, examples of actions may include, rewriting URLs, logging, adding protocol headers, redirecting network traffic, selected a policy, discard packets, or the like, or combination thereof.

As used herein the term “rule” refers to operands, conditions and actions combined together such that if a condition is met then the corresponding action is executed. In at least one of the various embodiments, conditions may be compound conditions that comprise multiple conditions. However, the actions corresponding to the rule may execute if the evaluation result of the entire condition is a true and/or affirmative result. In at least one of the various embodiments, actions may also be compound actions that may have multiple actions associated with a single rule.

As used herein the terms “policy rule set,” or “rule set” refer to a plurality of policy rules or rules grouped together based on various reasons, such as, semantic similarity, domain similarity, or the like. In at least one of the various embodiments, policy rules may be grouped into policy rule sets for arbitrary reasons that support the operational goals of a user/administrator of a traffic management device. In other embodiments, rule sets may be defined to support applications unrelated to network traffic management.

As used herein the term “policy engine” refers to a component of a traffic management device that is arranged to process rule sets. In at least one of the various embodiments, a policy engine may be arranged to execute using a decision tree compiled from one or more rule sets. Thus, in at least one of the various embodiments, conditions and actions executed by a policy engine may be expressed using declarative programming techniques and then compiled into a decision tree for concurrent evaluation.

As used herein the term “operand” refers to values that may be referenced in rules. Operands may be accessed in scripts, conditions, actions, or the like. One or more components of a traffic management device may generate the values for one or more operands. Also, scripts and actions may also create operands and/or modify their values. In at least one of the various embodiments, an operand may be an atomic value that can be referenced in rules. In at least one of the various embodiments, operands may include: simple operands (e.g. ‘HTTP::uri); named operands, which act like an associative array (e.g. ‘HTTP::header referrer’ or ‘HTTP::cookie session’); indexed operands, which require an index (e.g. ‘HTTP::query-parameter[l]’); or the like. In at least one of the various embodiments, operands may be typed. For example, operand types may include, string (e.g. HTTP::method, hostname), number (e.g. TCP::source-port), IP address (e.g. TCP::souce-address), Boolean, or the like. In at least one of the various embodiments, an operand reference translates to a value. In the case of a simple operand this may be the operand itself, in the case of a named operand it may be the operand+name, in the case of an indexed operand it may be the operand+index. Also, in at least one of the various embodiments, operands may belong to different domains and can have different lifetimes. In at least one of the various embodiments, operands may be provided for and/or by applications unrelated to network traffic management.

As used herein the term “decision tree” refers to a decision tree compiled from a rule set. Decision trees may be stored memory and employed by applications such as a policy engine to evaluate operands and conditions that correspond to the rules in the rule set.

As used herein the term “node” refers to a vertex in the decision tree. Nodes may include one or more rules or rule references and/or a condition expression. Nodes in a decision tree that reference a single rule may be considered a match node. If a match node is reached, the decision tree has completed the evaluation of the provided operands and the corresponding rule may be considered to be matched. In some embodiments, decision trees may include a node that represents a ‘no-match’ meaning the input operands do not match any of the rules in the rule set.

As used herein the terms “transition,” or “transition point” refer to a one or more nodes in the decision tree that may be reached from a current node. The number of transition points associated with a node is based on the number of possible results for the node's evaluator. The determination of which transition point to follow may be based on a result produced by the current node's evaluator.

The following briefly describes the various embodiments to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards concurrent evaluation of large rule sets with conditions. In at least one of the various embodiments, a rule compiler may receive one or more rule sets where each rule set includes one or more rules for policy management. In at least one of the various embodiments, during compilation by the rule compiler, one or more root nodes may be generated that include one or more rules. In some embodiments, one of the root nodes may be set to the current node in during the building of a decision tree used for evaluating the rule sets. In at least one of the various embodiments, the most common operand that is included in the at least one rules may be determined by examining all of the rules in the rule set. In at least one of the various embodiments, one or more conditions corresponding to previously determined most common operand may be determined by the rule compiler.

Next, in at least one of the various embodiments, one or more evaluators that correspond to the most common operand and its condition may be generated. In at least one of the various embodiments, each evaluator may be arranged to include one or more transition points that point to another node in the decision tree. In at least one of the various embodiments, if there are two or more rules associated with one or more of the transition points, the rule compiler may generate another node for the two or more rules that may be associated with the at least one transition point. In at least one of the various embodiments, if one or more of the transition points corresponds to a single rule absent any condition, the rule compiler may generate a match node for the single rule. In at least one of the various embodiments, completed decisions trees may be stored in memory and deployed for execution in a policy engine. In at least one of the various embodiments, the decision tree may be serialized into a compact form before storing it memory and deploying it to the policy engine.

In at least one of the various embodiments, evaluators may include tries (prefix trees) for testing for concurrent conditions that include string patterns. Also, in at least one of the various embodiments, evaluators may include hash tables for concurrently testing conditions that include “equals” or equivalency tests.

In at least one of the various embodiments, during execution by an application, such as, a policy engine, upon determination of a final match node, one or more actions that correspond the match node and/or to a rule in the rule set may be triggered. In at least one of the various embodiments, the actions for execution may be further determined based on a policy strategy. In at least one of the various embodiments, policy strategies may be arranged to determine which rule actions may be executed if a decision made using the decision tree resolves to multiple rules.

### Illustrative Operating Environment

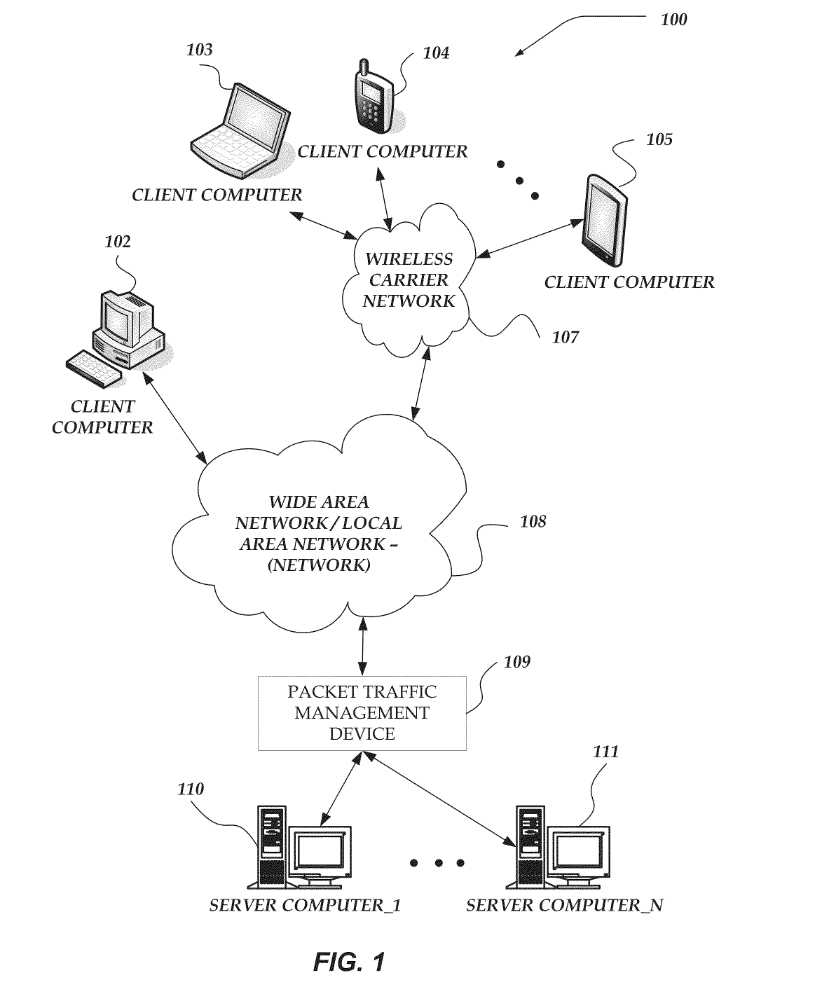

FIG. 1 shows components of one embodiment of an environment in which the invention may be practiced. Not all of the components may be required to practice the invention, and variations in the arrangement and type of the components may be made without departing from the spirit or scope of the invention.

As shown, system 100 of FIG. 1 includes local area networks (“LANs”)/wide area networks (“WANs”)-(network) 108, wireless network 107, client computers 102-105, packet traffic management device (“PTMD”) 109, and server computers 110-111. Network 108 is in communication with and enables communication between client computers 102-105, wireless network 107, and PTMD 109. Wireless carrier network 107 further enables communication with wireless devices, such as client computers 103-105. PTMD 109 is in communication with network 108 and server computers 110-111.

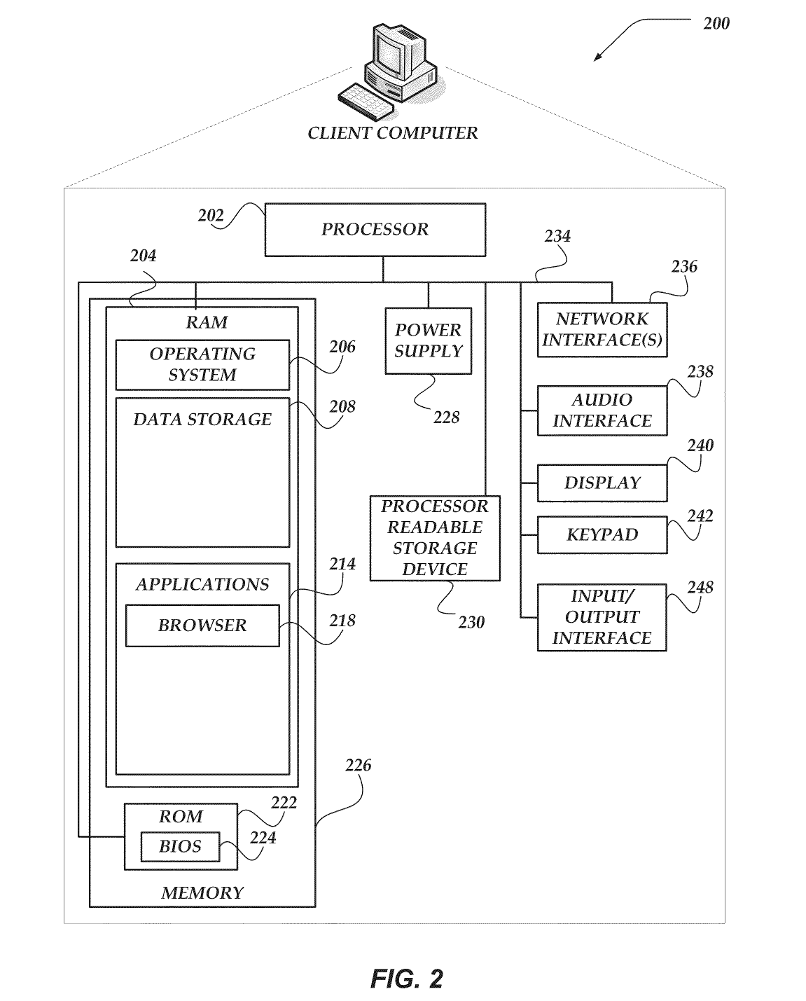

One embodiment of client computers 102-105 is described in more detail below in conjunction with FIG. 2. In one embodiment, at least some of client computers 102-105 may operate over a wired and/or a wireless network, such as networks 107 and/or 108. Generally, client computers 102-105 may include virtually any computing device capable of communicating over a network to send and receive information, including instant messages, performing various online activities, or the like. It should be recognized that more or less client computers may be included within a system such as described herein, and embodiments are therefore not constrained by the number or type of client computers employed.

Devices that may operate as client computer 102 may include devices that typically connect using a wired or wireless communications medium, such as personal computers, servers, multiprocessor systems, microprocessor-based or programmable consumer electronics, network PCs, or the like. In some embodiments, client computers 102-105 may include virtually any portable computing device capable of connecting to another computing device and receiving information, such as laptop computer 103, smart phone 104, tablet computer 105, or the like. However, portable computer devices are not so limited and may also include other portable devices, such as cellular telephones, display pagers, radio frequency (“RF”) devices, infrared (“IR”) devices, Personal Digital Assistants (“PDAs”), handheld computers, wearable computers, integrated devices combining one or more of the preceding devices, and the like. As such, client computers 102-105 typically range widely in terms of capabilities and features. Moreover, client computers 102-105 may provide access to various computing applications, including a browser, or other web-based applications.

A web-enabled client computer may include a browser application that is configured to receive and to send web pages, web-based messages, and the like. The browser application may be configured to receive and display graphics, text, multimedia, and the like, employing virtually any web-based language, including a wireless application protocol messages (“WAP”), and the like. In one embodiment, the browser application is enabled to employ Handheld Device Markup Language (“HDML”), Wireless Markup Language (“WML”), WMLScript, JavaScript, Standard Generalized Markup Language (“SGML”), HyperText Markup Language (“HTML”), eXtensible Markup Language (“XML”), and the like, to display and send a message. In one embodiment, a user of the client computer may employ the browser application to perform various activities over a network (online). However, another application may also be used to perform various online activities.

Client computers 102-105 also may include at least one other client application that is configured to receive and/or send data between another computing device. The client application may include a capability to send and/or receive content, or the like. The client application may further provide information that identifies itself, including a type, capability, name, or the like. In one embodiment, client computers 102-105 may uniquely identify themselves through any of a variety of mechanisms, including a phone number, Mobile Identification Number (“MIN”), an electronic serial number (“ESN”), or other mobile device identifier. The information may also indicate a content format that the mobile device is enabled to employ. Such information may be provided in a network packet, or the like, sent between other client computers, PTMD 109, server computers 110-111, or other computing devices.

Client computers 102-105 may further be configured to include a client application that enables an end-user to log into an end-user account that may be managed by another computing device, such as server computers 110-111, or the like. Such end-user account, in one non-limiting example, may be configured to enable the end-user to manage one or more online activities, including in one non-limiting example, search activities, social networking activities, browse various websites, communicate with other users, participate in gaming, interact with various applications, or the like. However, participation in online activities may also be performed without logging into the end-user account.

Wireless carrier network 107 is configured to couple client computers 103-105 and its components with network 108. Wireless carrier network 107 may include any of a variety of wireless sub-networks that may further overlay stand-alone ad-hoc networks, and the like, to provide an infrastructure-oriented connection for client computers 102-105. Such sub-networks may include mesh networks, Wireless LAN (“WLAN”) networks, cellular networks, and the like. In one embodiment, the system may include more than one wireless network.

Wireless carrier network 107 may further include an autonomous system of terminals, gateways, routers, and the like connected by wireless radio links, and the like. These connectors may be configured to move freely and randomly and organize themselves arbitrarily, such that the topology of wireless carrier network 107 may change rapidly.

Wireless carrier network 107 may further employ a plurality of access technologies including 2nd (2G), 3rd (3G), 4th (4G) 5^{th} (5G) generation radio access for cellular systems, WLAN, Wireless Router (“WR”) mesh, and the like. Access technologies such as 2G, 3G, 4G, 5G, and future access networks may enable wide area coverage for mobile devices, such as client computers 103-105 with various degrees of mobility. In one non-limiting example, wireless carrier network 107 may enable a radio connection through a radio network access such as Global System for Mobil communication (“GSM”), General Packet Radio Services (“GPRS”), Enhanced Data GSM Environment (“EDGE”), code division multiple access (“CDMA”), time division multiple access (“TDMA”), Wideband Code Division Multiple Access (“WCDMA”), High Speed Downlink Packet Access (“HSDPA”), Long Term Evolution (“LTE”), and the like. In essence, wireless carrier network 107 may include virtually any wireless communication mechanism by which information may travel between client computers 103-105 and another computing device, network, and the like.

Network 108 is configured to couple network computers with other computing devices, including, server computers 110-111 through PTMD 109, client computer 102, and client computers 103-105 through wireless network 107. Network 108 is enabled to employ any form of computer readable media for communicating information from one electronic device to another. Also, network 108 can include the Internet in addition to LANs, WANs, direct connections, such as through a universal serial bus (“USB”) port, other forms of computer readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (“ISDNs”), Digital Subscriber Lines (“DSLs”), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 108 may be configured to transport information of an Internet Protocol (“IP”). In essence, network 108 includes any communication method by which information may travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

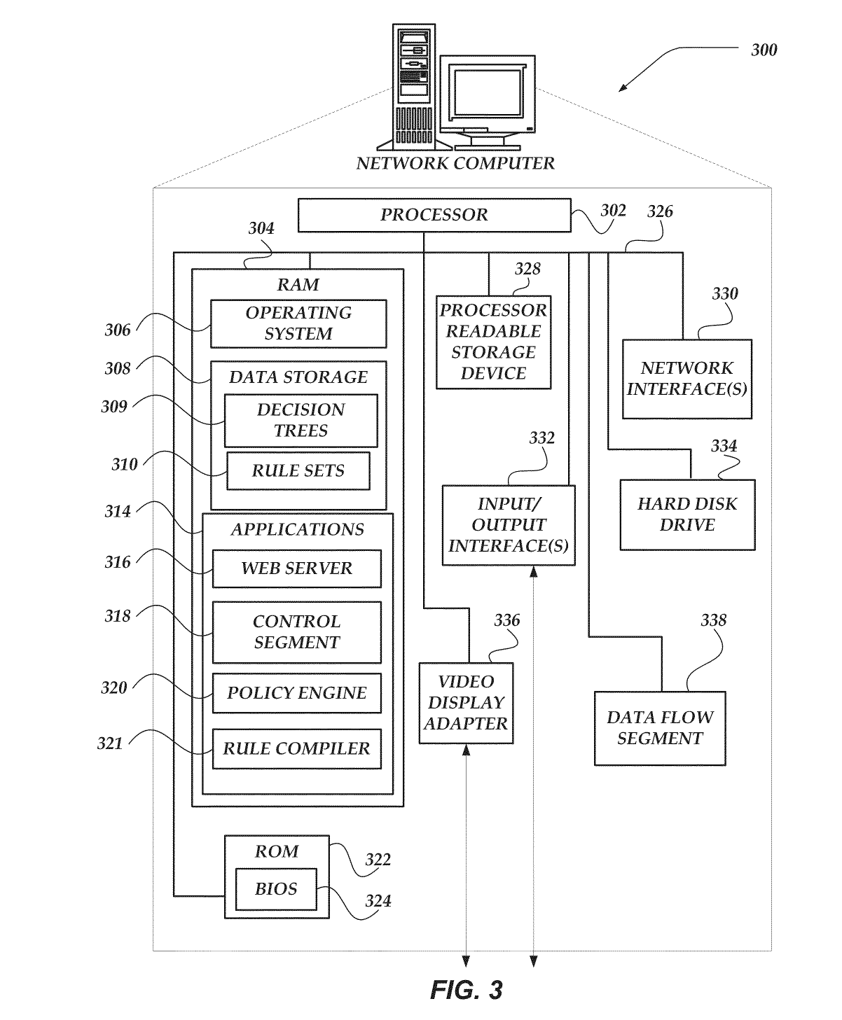

One embodiment of PTMD 109 is described in more detail below in conjunction with FIG. 3. Briefly, however, PTMD 109 may include virtually any network computer capable of managing network traffic between client computers 102-105 and server computers 110-111. Such devices include, for example, routers, proxies, firewalls, load balancers, cache devices, devices that perform network address translation, or the like, or any combination thereof. PTMD 109 may perform the operations of routing, translating, switching packets, or the like. In one embodiment, PTMD 109 may inspect incoming network packets, and may perform an address translation, port translation, a packet sequence translation, and the like, and route the network packets based, at least in part, on the packet inspection. In some embodiments, PTMD 109 may perform load balancing operations to determine a server computer to direct a request. Such load balancing operations may be based on network traffic, network topology, capacity of a server, content requested, or a host of other traffic distribution mechanisms.

PTMD 109 may include a control segment and a separate data flow segment. The control segment may include software-optimized operations that perform high-level control functions and per-flow policy enforcement for packet traffic management. In at least one of the various embodiments, the control segment may be configured to manage connection flows maintained at the data flow segment. In one embodiments, the control segment may provide instructions, such as, for example, a packet translation instruction, to the data flow segment to enable the data flow segment to route received packets to a server computer, such as server computer 110-111. The data flow segment may include hardware-optimized operations that perform statistics gathering, per-packet policy enforcement (e.g., packet address translations), high-speed flow caches, or the like, on connection flows maintained at DFS between client computers, such as client computers 102-105, and server computers, such as server computers 110-111.

Server computers 110-111 may include virtually any network computer that may operate as a website server. However, server computers 110-111 are not limited to website servers, and may also operate as messaging server, a File Transfer Protocol (FTP) server, a database server, content server, or the like. Additionally, each of server computers 110-111 may be configured to perform a different operation. Devices that may operate as server computers 110-111 include various network computers, including, but not limited to personal computers, desktop computers, multiprocessor systems, microprocessor-based or programmable consumer electronics, network PCs, server computers, network appliances, and the like.

Although FIG. 1 illustrates server computers 110-111 as single computing devices, the invention is not so limited. For example, one or more functions of each of server computers 110-111 may be distributed across one or more distinct network computers. Moreover, server computers 110-111 are not limited to a particular configuration. Thus, in one embodiment, server computers 110-111 may contain a plurality of network computers that operate using a master/slave approach, where one of the plurality of network computers of server computers 110-111 operate to manage and/or otherwise coordinate operations of the other network computers. In other embodiments, the server computers 110-111 may operate as a plurality of network computers within a cluster architecture, a peer-to-peer architecture, and/or even within a cloud architecture. Thus, the invention is not to be construed as being limited to a single environment, and other configurations, and architectures are also envisaged.

### Illustrative Client Computer

FIG. 2 shows one embodiment of client computer 200 that may be included in a system implementing embodiments of the invention. Client computer 200 may include many more or less components than those shown in FIG. 2. However, the components shown are sufficient to disclose an illustrative embodiment for practicing the present invention. Client computer 200 may represent, for example, one embodiment of at least one of client computers 102-105 of FIG. 1.

As shown in the figure, client computer 200 includes a processor 202 in communication with memory 226 via a bus 234. Client computer 200 also includes a power supply 228, one or more network interfaces 236, an audio interface 238, a display 240, a keypad 242, and an input/output interface 248.

Power supply 228 provides power to client computer 200. A rechargeable or non-rechargeable battery may be used to provide power. The power may also be provided by an external power source, such as an AC adapter or a powered docking cradle that supplements and/or recharges a battery.

Client computer 200 may optionally communicate with a base station (not shown), or directly with another computing device. Network interface 236 includes circuitry for coupling client computer 200 to one or more networks, and is constructed for use with one or more communication protocols and technologies including, but not limited to, global system for mobile communication (“GSM”), code division multiple access (“CDMA”), time division multiple access (“TDMA”), High Speed Downlink Packet Access (“HSDPA”), Long Term Evolution (“LTE”), user datagram protocol (“UDP”), transmission control protocol/Internet protocol (“TCP/IP”), short message service (“SMS”), general packet radio service (“GPRS”), WAP, ultra wide band (“UWB”), IEEE 802.16 Worldwide Interoperability for Microwave Access (“WiMax”), session initiated protocol/real-time transport protocol (“SIP/RTP”), or any of a variety of other wireless communication protocols. Network interface 236 is sometimes known as a transceiver, transceiving device, or network interface card (“NIC”).

Audio interface 238 is arranged to produce and receive audio signals such as the sound of a human voice. For example, audio interface 238 may be coupled to a speaker and microphone (not shown) to enable telecommunication with others and/or generate an audio acknowledgement for some action.

Display 240 may be a liquid crystal display (“LCD”), gas plasma, light emitting diode (“LED”), or any other type of display used with a computing device. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images.

Client computer 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like.

Client computer 200 may also include a GPS transceiver (not shown) to determine the physical coordinates of client computer 200 on the surface of the Earth. A GPS transceiver typically outputs a location as latitude and longitude values. However, the GPS transceiver can also employ other geo-positioning mechanisms, including, but not limited to, triangulation, assisted GPS (“AGPS”), Enhanced Observed Time Difference (“E-OTD”), Cell Identifier (“CI”), Service Area Identifier (“SAI”), Enhanced Timing Advance (“ETA”), Base Station Subsystem (“BSS”), or the like, to further determine the physical location of client computer 200 on the surface of the Earth. It is understood that under different conditions, a GPS transceiver can determine a physical location within millimeters for client computer 200; and in other cases, the determined physical location may be less precise, such as within a meter or significantly greater distances. In one embodiment, however, mobile device 200 may communicate through other components, provide other information that may be employed to determine a physical location of the device, including for example, a Media Access Control (“MAC”) address, IP address, or the like.

Memory 226 includes a Random Access Memory (“RAM”) 204, a Read-only Memory (“ROM”) 222, and other storage means. Mass memory 226 illustrates an example of computer readable storage media (devices) for storage of information such as computer readable instructions, data structures, program modules or other data. Mass memory 226 stores a basic input/output system (“BIOS”) 224 for controlling low-level operation of client computer 200. The mass memory also stores an operating system 206 for controlling the operation of client computer 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Mass memory 226 further includes one or more data storage 208, which can be utilized by client computer 200 to store, among other things, applications 214 and/or other data. For example, data storage 208 may also be employed to store information that describes various capabilities of client computer 200. The information may then be provided to another device based on any of a variety of events, including being sent as part of a header during a communication, sent upon request, or the like. Data storage 208 may also be employed to store social networking information including address books, buddy lists, aliases, user profile information, or the like. Further, data storage 208 may also store message, we page content, or any of a variety of user generated content. At least a portion of the information may also be stored on another component of network computer 200, including, but not limited to processor readable storage device 230, a disk drive or other computer readable storage medias (not shown) within client computer 200.

Processor readable storage device 230 may include volatile, nonvolatile, non-transitory, removable, and non-removable media implemented in any method or technology for storage of information, such as computer- or processor-readable instructions, data structures, program modules, or other data. Examples of computer readable storage media include RAM, ROM, Electrically Erasable Programmable Read-only Memory (“EEPROM”), flash memory or other memory technology, Compact Disc Read-only Memory (“CD-ROM”), digital versatile disks (“DVD”) or other optical storage, magnetic cassettes, magnetic tape, magnetic disk storage or other magnetic storage devices, or any other physical medium which can be used to store the desired information and which can be accessed by a computing device. Processor readable storage device 230 may also be referred to herein as computer readable storage media.

Applications 214 may include computer executable instructions which, when executed by client computer 200, transmit, receive, and/or otherwise process network data. Network data may include, but is not limited to, messages (e.g., SMS, Multimedia Message Service (“MMS”), instant message (“IM”), email, and/or other messages), audio, video, and enable telecommunication with another user of another client computer. Applications 214 may include, for example, browser 218. Applications 214 may include other applications, which may include, but are not limited to, calendars, search programs, email clients, IM applications, SMS applications, voice over Internet Protocol (“VOIP”) applications, contact managers, task managers, transcoders, database programs, word processing programs, security applications, spreadsheet programs, games, search programs, and so forth.

Browser 218 may include virtually any application configured to receive and display graphics, text, multimedia, and the like, employing virtually any web based language. In one embodiment, the browser application is enabled to employ HDML, WML, WMLScript, JavaScript, SGML, HTML, XML, and the like, to display and send a message. However, any of a variety of other web-based programming languages may be employed. In one embodiment, browser 218 may enable a user of client computer 200 to communicate with another network computer, such as PTMD 109 and/or indirectly with server computers 110-111.

### Illustrative Network Computer

FIG. 3 shows one embodiment of network computer 300, according to one embodiment of the invention. Network computer 300 may include many more or less components than those shown. The components shown, however, are sufficient to disclose an illustrative embodiment for practicing the invention. Network computer 300 may be configured to operate as a server, client, peer, a host, or any other device. Network computer 300 may represent, for example PTMD 109 of FIG. 1, server computers 110-111 of FIG. 1, and/or other network computers.

Network computer 300 includes processor 302, processor readable storage device 328, network interface unit 330, an input/output interface 332, hard disk drive 334, video display adapter 336, data flow segment (“DFS”) 338 and a mass memory, all in communication with each other via bus 326. The mass memory generally includes RAM 304, ROM 322 and one or more permanent mass storage devices, such as hard disk drive 334, tape drive, optical drive, and/or floppy disk drive. The mass memory stores operating system 306 for controlling the operation of network computer 300. Any customized/specialized or general-purpose operating system may be employed. Basic input/output system (“BIOS”) 324 is also provided for controlling the low-level operation of network computer 300. As illustrated in FIG. 3, network computer 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (“NIC”).

Network computer 300 also comprises input/output interface 332 for communicating with external devices, such as a keyboard, or other input or output devices not shown in FIG. 3. Input/output interface 332 can utilize one or more communication technologies, such as USB, infrared, Bluetooth™, or the like.

The mass memory as described above illustrates another type of computer readable media, namely computer readable storage media and/or processor readable storage media, including processor readable storage device 328. Processor readable storage device 328 may include volatile, nonvolatile, non-transitory, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computing device.

Data storage 308 may include a database, text, spreadsheet, folder, file, or the like, that may be configured to maintain and store user account identifiers, user profiles, email addresses, IM addresses, and/or other network addresses; or the like. Data stores 308 may further include program code, data, algorithms, and the like, for use by a processor, such as central processing unit 302 to execute and perform actions. In one embodiment, at least some of data store 308 might also be stored on another component of network computer 300, including, but not limited to processor-readable storage device 328, hard disk drive 334, or the like. In at least one of the various embodiments, data storage 308 may include compiled decision trees 309, and rule sets 310.

The mass memory may also stores program code and data. One or more applications 314 may be loaded into mass memory and run on operating system 306. Examples of application programs may include transcoders, schedulers, calendars, database programs, word processing programs, Hypertext Transfer Protocol (“HTTP”) programs, customizable user interface programs, IPSec applications, encryption programs, security programs, SMS message servers, IM message servers, email servers, account managers, and so forth. Web server 316 and control segment (“CS”) 318 may also be included as application programs within applications 314.

Web server 316 represent any of a variety of services that are configured to provide content, including messages, over a network to another computing device. Thus, web server 316 includes, for example, a web server, a File Transfer Protocol (“FTP”) server, a database server, a content server, or the like. Web server 316 may provide the content including messages over the network using any of a variety of formats including, but not limited to WAP, HDML, WML, SGML, HTML, XML, Compact HTML (“cHTML”), Extensible HTML (“xHTML”), or the like. Web server 316 may also be configured to enable a user of a client computer, such as client computers 102-105 of FIG. 1, to browse websites, upload user data, or the like.

Network computer 300 may also include DFS 338 for maintaining connection flows between client computers, such as client computers 102-105 of FIG. 1, and server computers, such as server computers 110-111 of FIG. 1. In one embodiment, DFS 338 may include hardware-optimized operations for packet traffic management, such as repetitive operations associated with packet traffic management. For example, DFS 338 may perform statistics gathering, per-packet policy enforcement (e.g., packet address translations), or the like, on connection flows maintained at DFS 338. In some embodiments, DFS 338 may route, switch, forward, and/or otherwise direct packets based on rules for a particular connection flow signature (e.g., a 5 tuple of a received packet). Thus, DFS 338 may include capabilities and perform tasks such as that of a router, a switch, a routing switch, or the like. In some embodiments, the rules for a particular connection flow signature may be based on instructions received from CS 318. In one embodiment, DFS 338 may store the instructions received from CS 318 in a local memory as a table or some other data structure. In some other embodiments, DFS 338 may also store a flow state table to indicate a state of current connection flows maintained at DFS 338. In at least one of the various embodiments, components of DFS 338 may comprise and/or work in combination to provide high-speed flow caches for optimizing packet traffic management. In at least one of the various embodiments, DFS 338 may comprise high-speed memory such as SRAM to improve performance.

In at least one of the various embodiments, policy engine 320 may be a specialized component arranged for processing, and executing declarative policy rules. Policy engine 320 may be implemented in software or hardware, or a combination thereof. Rule compiler 321 may be a specialized component arranged for processing and/or compile rule sets for concurrent evaluation.

### Illustrative Logical System Architecture

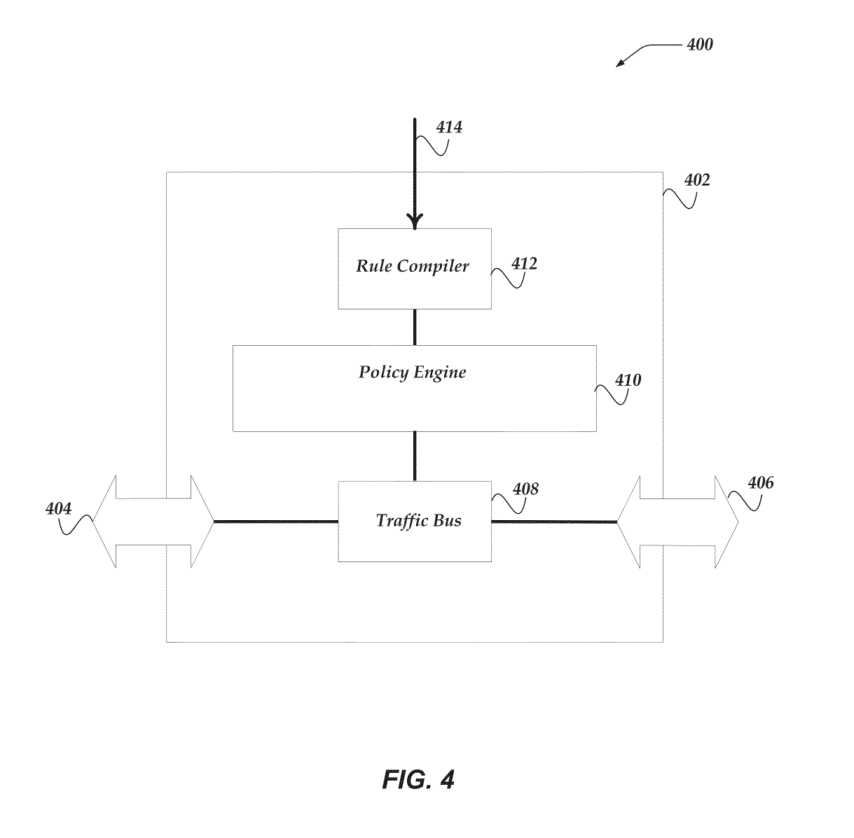

FIG. 4 illustrates a portion of logical architecture 400 for the concurrent evaluation of large rule sets with conditions in accordance with at least one of the embodiments. In at least one of the various embodiments, architecture 400, includes a network traffic management system, such as, system 402. In at least one of the various embodiments, system 402 may be a traffic management device, such as, PTMD 109, or the like. In at least one of the various embodiments, system may be a component of a traffic management device, or the like. Further, in at least one of the various embodiments, system 402 may be operative in one or more virtual machines and/or operative in a cloud based environment. In some embodiment, system 402 may be a specialized hardware component include in a traffic management device, or other network computer.

In at least one of the various embodiments, network traffic 404 may be provided to system 402 using one or more network interfaces, such as, network interfaces 330 in FIG. 3. After processing, network traffic passing through system 402 may exit by way of network interface 406. In at least one of the various embodiments, network traffic may include one or more network flows, connection flows, half-connection flows, or the like, or combination thereof. Further, in at least one of the various embodiments, network traffic may flow in both directions, with some portion of the network traffic entering and/or exiting from either or both network interface 404 or network interface 406.

In at least one of the various embodiments, system 402 may include traffic bus 408 that may be arranged so the network traffic passing through system 402 goes through bus 408. In at least one of the various embodiments, bus 408 may comprise multiple electronic hardware and/or software components having one or more network paths that enable network traffic to flow through system 402.

In at least one of the various embodiments, policy engine 410 may be integrated into system 402 such that it may be enabled to monitor and access the network flows that may be passing through bus 408. In at least one of the various embodiments, policy engine 410 may be arranged to access some or all of the network traffic passing through traffic bus 408.

In at least one of the various embodiments, policy engine 410 may be arranged to execute rule based policies that may be expressed using declarative expressions. In at least one of the various embodiments, declarative expressions may comprise operands, operators, and functions that have been pre-declared either as part of policy engine 410 or in one or more components for network computer 300, such as, policy engine 320. Further, policy engine 410 may be arranged to use one or more decision tree for executing the rule based policies. Rules and rule sets for policies may be compiled by rule compiler 412 before being provided and/or deployed to policy engine 410.

In at least one of the various embodiments, policy engine 410 may be arranged to access one or more values in the traffic management device that represent the status, metrics, and/or characteristics of the network flows that may be passing through traffic bus 408. In some case, these values may be stored in memory buffers, registers, memory, or the like, that are implemented in software or hardware, or a combination thereof. In at least one of the various embodiments, the values may be associated with names and/or identifiers such that they may be used in declarative expressions created by users.

In at least one of the various embodiments, policy engine 410 may be integrated into system 402 such that it can monitor and access the network flows that may be passing through bus 408. In at least one of the various embodiments, policy engine 410 may be arranged to access some or all of the network traffic passing through traffic bus 408.

In at least one of the various embodiments, rule compiler 412 may be arranged to compile rules and/or rule sets into decision trees that may enable concurrent evaluation of rule sets. In at least one of the various embodiments, rules and/or rule sets may be generated by a user or other source 414. In at least one of the various embodiments, the provided rules may be written in any various well-known computer programming language, custom programming language, text, or the like, that enable the expression of declarative statements.

One of ordinary skill in the art will appreciate that architecture 400 and system 402 is a simplified representation of a traffic management device arranged in accordance with at least one of the various embodiments. As such, many components necessary for an operative traffic management device are not illustrated. However, architecture 400 and system 402 as shown, enable one of ordinary skill the art to understand and practice at least the innovations disclosed herein.

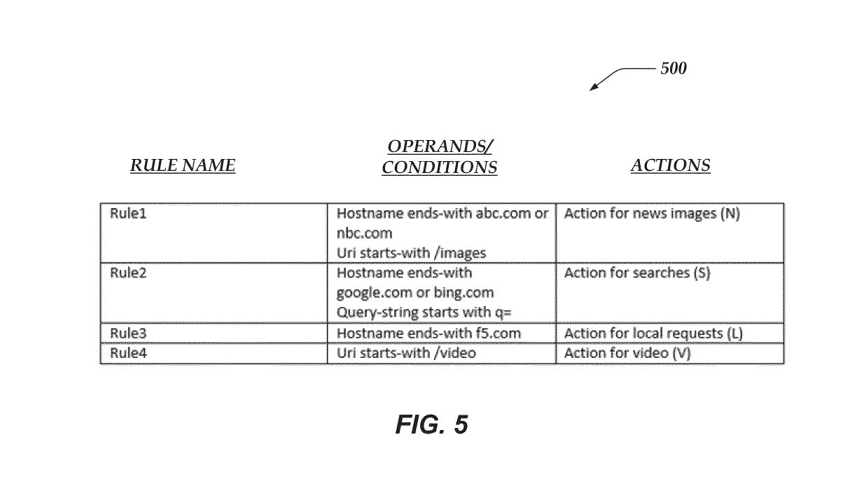

FIG. 5 illustrates table 500 that includes four illustrative policy rules in accordance with at least one of the various embodiments. In at least one of the various embodiments, rules may be expressed in various structures or formats, including, text, XML, HTML, CSV, or the like. Likewise, in at least one of the various embodiments, rules may be stored in files, database tables, memory (static or dynamic), removable computer readable media (e.g., memory cards, optical disks, or the like), magnetic hard drives, or the like. Further, even though table 500 illustrates rules as having three components (rule name, operands/conditions, and actions) the innovations described herein are not limited to this particular organization of rule sets. Rule sets may be organized using one or more well-known data structures, such as, lists, arrays, hash tables, trees, graphs, or the like.

Table 500 represents an illustrative example of a rule sets that may be referenced in this description to describe the concurrent evaluation of large rule sets. In at least one of the various embodiments, rules may include a name, a set of one or more operands and conditions, and a set of one or more actions. In at least one of the various embodiments, rule names, such as, Rule 1, Rule 2, Rule 3, and Rule 4, as in table 500, may be machine and/or human readable identifiers for addressing a particular rule. In at least one of the various embodiments, operands may include the name and/or identifier of one or more operands that may be employed in a rule.

In at least one of the various embodiments, operands may vary depending the type of rule sets and/or applications that arranged to employ these innovations. For example, in at least one of the various embodiments, if the application is arranged for managing HTTP network traffic, operands may include one or more elements or properties of the HTTP protocol or other well-known networking properties that may be relevant to the management of HTTP traffic. Accordingly, in at least one of the various embodiments, for HTTP traffic management, operands may include, but not be limited to, hostname, URI, query string, cookie, HTTP response code, HTTP methods, source IP address, destination IP address, or the like. Likewise, in at least one of the various embodiments, operands for applications associated with the management of other networking protocols may include operands that correspond to one or more well-known properties of the particular network protocols being managed.

In at least one of the various embodiments, conditions may be one or more “tests” that an operand may be evaluated against. In at least one of the various embodiments, rules may include one or more conditions for each of one or more operands. In at least one of the various embodiments, conditions may include one or more test that evaluate to true or false. In at least one of the various embodiments, conditions may include pattern matching, value matching, arithmetic matching, or the like. For example, in at least one of the various embodiments, conditions may include: ends-with, for testing for patterns at the end of strings, starts-with, for testing for patterns at the beginning of strings, ‘includes’, for testing for patterning within strings, or the like. Also, in at least one of the various embodiments, numeric conditions may include conditions, such as, ‘<’, ‘<=’, ‘>’, ‘>=’ and ‘==’, or the like.

In at least one of the various embodiments, if the rule may be evaluated, a value for one or more of the operands may be provided for evaluating against one or more of the rule's conditions. If all the conditions for the rule may be met, the rule may be considered to be matched. Accordingly, the one more actions corresponding a matched rule may be executed by the application that employs the rule set.

For example, in at least one of the various embodiments, a user may provide a rule set, such as, those illustrated in table 500, to a rule compiler, such as, rule compiler 412, in FIG. 4. The rule compiler may generate a compiled rule set to policy engine 410 which may employ the rule set for network traffic management. And, in this example, operand information may be retrieved from the network traffic passing through traffic bus 408.

In at least one of the various embodiments, rule set may be provided in an un-compiled format such as those illustrated in table 500. In at least one of the various embodiments, to enable concurrent evaluation of the rule set, the rules, such as, those in table 500, may be compiled into a decision tree that may perform concurrent evaluation. In at least one of the various embodiments, a rule compiler, such as, rule compiler 412 and/or rule compiler 321, may be arranged to determine the most common operands and conditions for those operands that may be in a rule set. Accordingly, if one or more conditions associated with a common operand may be determined to be eligible for concurrent evaluation, an evaluator for the operand-condition pair may be generated. For example, in at least one of the various embodiments, looking at the rule set in table 500, the most common operand is ‘hostname’ and the most common operand that is application to hostname is ‘ends-with’.

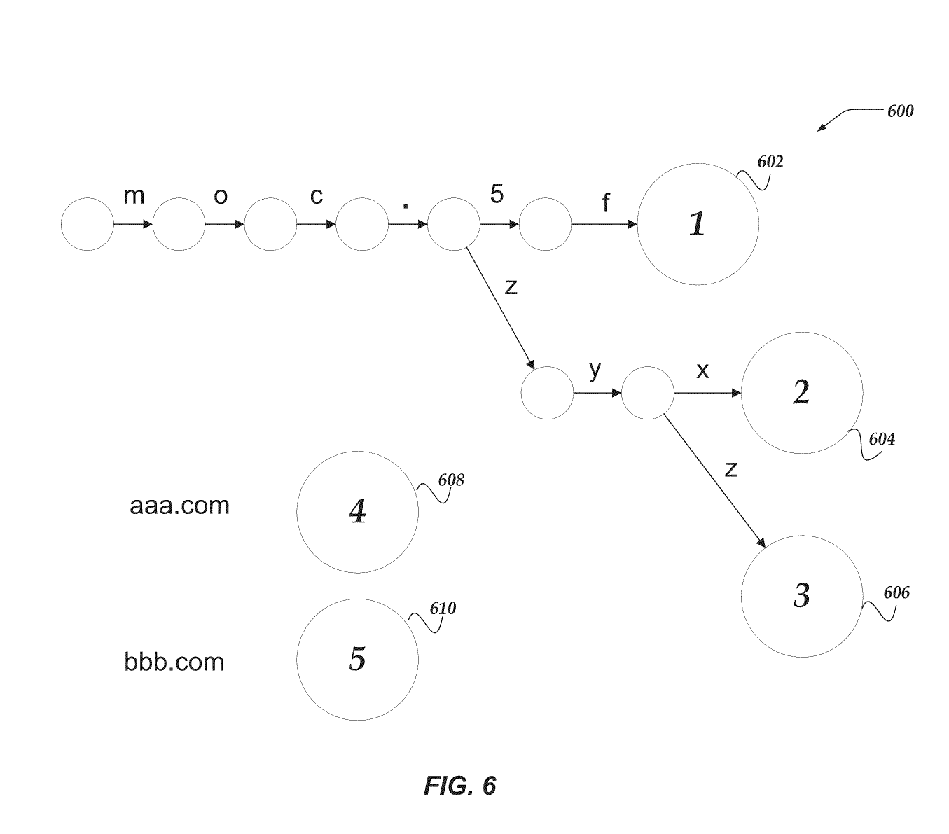

In at least one of the various embodiments, the rule compiler may be arranged to generate evaluators for the concurrent evaluation of the conditions. One or more well-known pattern matching techniques may be employed in the evaluators for a given condition. For example, evaluators for pattern matches may employ tries (prefix trees), evaluators for equality conditions may employ a hash table, numeric comparisons may employ one or more well-known forms of decision trees, or the like. In this example, since hostname is the most common operand and the most common condition for hostname is the string pattern match of ‘ends-with’, a tie may be generated for the concurrent evaluation of the all of the ends-with conditions. See, FIG. 6.

Further, in at least one of the various embodiments, the rule compiler may generate a node based decision tree for evaluation of the entire rule set. In at least one of the various embodiments, each operand and condition may correspond to either a node in the decision tree. In at least one of the various embodiments, non-leaf nodes may include one or more rules, operands and a condition (associated with an evaluator) while leaf nodes may represent a rule match.

Accordingly, in at least one of the various embodiments, during execution of the rule set (as opposed to compilation), nodes in the decision tree may be traversed until a leaf node may be reached. If a leaf node is reached, the actions associated with one or more corresponding matched rules may be triggered.

In at least one of the various embodiments, beginning at the root node, the rule compiler may arrange each evaluator to include transition information for each potential result and/or outcomes for the evaluator. Thus, in at least one of the various embodiments, this transition information may be used to determine the next node in the rule set's decisions tree to be processed during execution time.

FIG. 6 shows an illustrative example of evaluator 600 for evaluating a condition in a rule set in accordance with at least one of the various embodiments. In particular, evaluator 600 is an example of a trie that may be generated by a rule compiler, such as, rule compiler 412 and/or rule compiler 321. In this example, (refer to rule set table 500 as necessary since the rules in table 500 are used in these examples) Hostname is a string operand associated with conditions in the rule set that may be concurrently evaluated with a trie. This example shows how, in at least one of the various embodiments, how five patterns (f5.com, xyz.com, zyz.com, aaa.com, qqq.com), may be concurrently tested for using one evaluator. According to the well-known operation of pattern matching with a trie, the hostname value may be evaluated until one of result 602, result 604, result 606, result 608, result 610, or a ‘no match’ result may be determined. In at least one of the various embodiments, each result may correspond to a transition to a node in the decision tree. In this example, the numerals 1-5 in the results correspond to the transition points for this evaluator that may be mapped to nodes in the decision tree. Note, evaluator 600 is an example of an evaluator that evaluates one operand/condition pair included in rule set 500, namely, the “Hostname ends-with” operand/condition pair. The rule compiler may generate evaluators that correspond to the other operand/condition pairs in the rule set.

In at least one of the various embodiments, each evaluator may be arranged to transition to a node in the decision tree depending on the result. In at least one of the various embodiments, transition points may correspond to a node in the decision tree. In at least one of the various embodiments, more than one transition point may go to the same node. In at least one of the various embodiments, each potential different result in of an evaluator may be associated with a transition point. However, in some embodiments, some transition points may point to the same node.

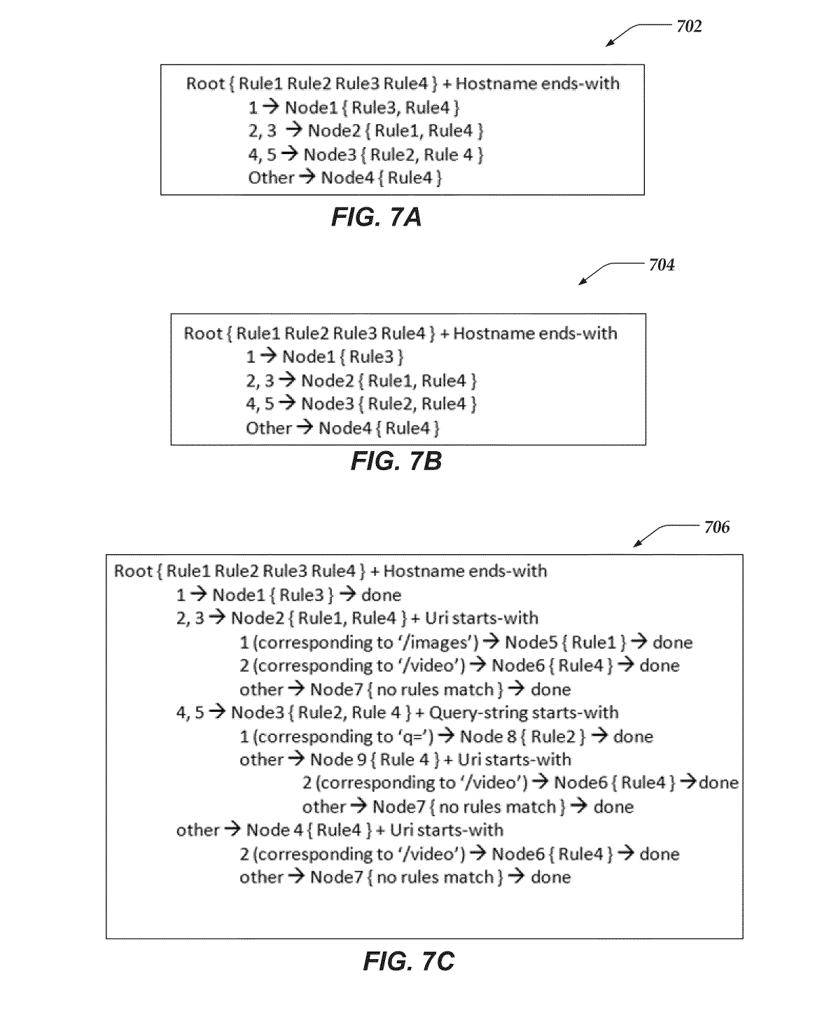

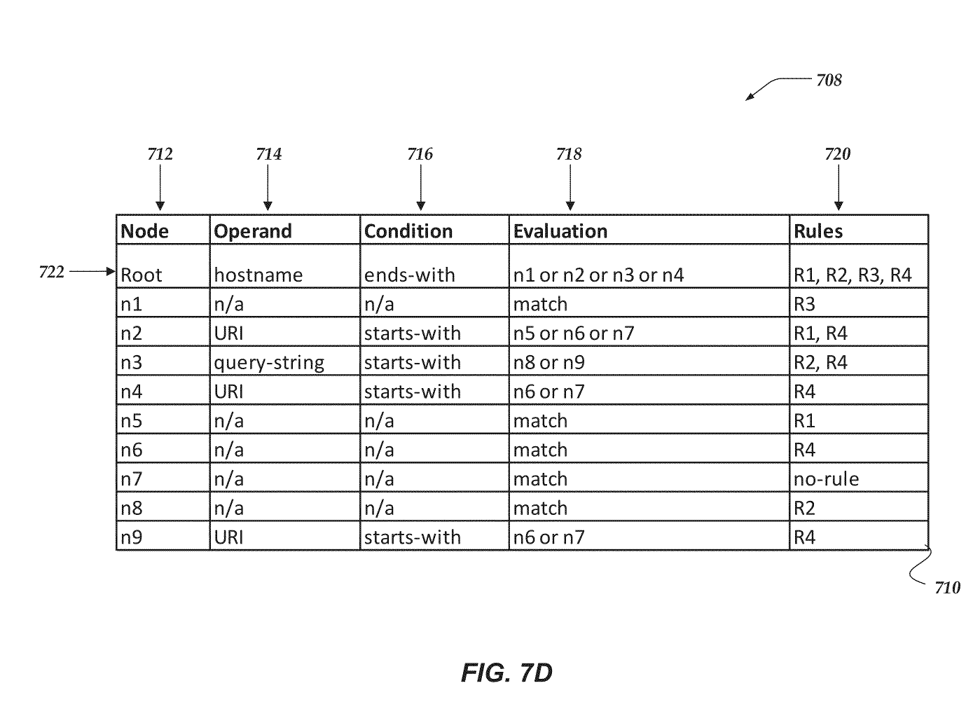

For example, if a request that includes a Hostname value that ends with ‘f5.com’ is included in a request, evaluator 600 will resolve to result 602 which will transition the node that corresponds with transition point 1 (Node 1 in this example, See FIGS. 7A-D). Likewise, a request having a Hostname that ends-with abc.com will produce a result (result 604) is a transition the that corresponds to transition point 2 (Node 2 in this example), and so on.

In at least one of the various embodiments, nodes in the decision tree will be one of nodes that require further evaluation using other evaluators, match nodes, or a no-match node. Looking ahead (generating decision trees is further discussed below), since result 602 is reached if Hostname ends with f5.com, it matches Rule 3 (in rule set 500). Thus, in this example, Node 1 will be a match node since the only way to arrive there is if the condition for Rule 3 is matched and there are no other conditions to test.

In contrast, in this example, if the hostname for a request ends in ‘xyz.com’, result 604 will be reached, transitioning decision tree to Node 2. Referring to rule set 500, Node 2 will not be a match node because there is another operation/condition to evaluate, the URL starts-with operand/condition pair. In this example, another evaluator corresponding to the operand/condition pair may be evaluated to see if its conditions are met. In this example, Rule 1 will be matched if the Hostname ends with ‘xyz.com’ or ‘zyz.com’ AND the URL starts with ‘/images’. Accordingly, Node 2 will be associated with an evaluator that tests for URL starts with values. Again, since at least two rules have the ‘URL starts with’ operand/condition pair, a single evaluator (another tie not shown) may be generated to test for either ‘/images’, for Rule 1, or ‘/video’ for Rule 4.

FIGS. 7A-7C illustrate compilation steps for generating a decision tree for a portion of a rule set in accordance with at least one of the various embodiments. In at least one of the various embodiments, a rule compiler, such as rule compiler 321, and/or rule compiler 412 may be arranged to compile a rule set, such as, rule set 500 into a decision tree that may enable concurrent evaluation of conditions and/or operands that may be included in the rule sets. In this example, Rule 1, Rule 2, Rule 3, and Rule 4 refer to the rules in rule set 500 in FIG. 5. FIG. 7D illustrates a tabular representation of a compiled decision tree produced by the actions described with FIG. 7A-7C.

FIG. 7A shows a first step for compiling decision tree 702 in accordance with at least one of the various embodiments. Using rule set 500 as an example, an application such as, rule compiler 312, may be arranged to generate a decision tree as described herein.

In at least one of the various embodiments, the rule compiler may be arranged to determine the most common operand from among the rules in the rule set as well as the most common condition (test) associated with the most common operand. In at least one of the various embodiments, the rule compiler may generate a root node for the decision tree that includes the most common operand, the determined condition test, and associate it with the all the rules in the rule set. In addition to generating the root node, the rule compiler may generate one or more evaluators that correspond to the condition for the node. For example, in at least one of the various embodiments, for rule set 500, the root node may include Rules 1-4, the operand ‘Hostname’ and the condition ‘ends-with’. Accordingly, for this example, since hostname is a string and ends-with is a string pattern match, an evaluator that includes a trie, such as, trie 600 may be generated for the root node for a decision tree generated for rule set 500.

In at least one of the various embodiments, after the root node is generated, the rule compiler, may generate additional nodes, one for each potential result produced by the evaluator. In some embodiments, there may be results representing transitions to a rule match node, or in other cases, transitions may point other nodes that require further testing before a rule match (or no-match) may be determined.

In at least one of the various embodiments, using rule set 500 and evaluator 600 as an example, decision tree 702 may be generated. FIG. 7A shows how results (transition points) from the evaluator may be resolved to nodes in the decision tree. Accordingly, result 602 may indicate a transition to Node 1, result 604 and result 606 may indicate a transition to Node 2, result 4 and result 5 may indicate a transition to Node 3, and a no-match (‘other’) may indicate a transition to Node 4. In this example, the five transition points from FIG. 6 correspond to the 1-5 transition points shown in FIG. 7A.

In at least one of the various embodiments, each node may be associated with at least one rule, as discussed above, the root node may be associated with all rules in the rule set, while Node 1, for example, is associated with Rule 3. In at least one of the various embodiments, Rule 3 is associated with Node 1 because the condition for Rule 3 is the condition that is matched by result 602 in evaluator 600. Likewise, in this example, Rule 1 is associated with Node 2 because the conditions matched for result 604 and result 606 in evaluator 600 correspond to Rule 1. And, in at least one of the various embodiments, Rule 2 is associated with Node 3 because the conditions matched by result 608 and result 610 correspond to Rule 2. Node 4 may be generated to further test operands that may be non-matches that may not correspond to a result in evaluator 600.

Further, in at least one of the various embodiments, at this step, the rule compiler may be arranged to include rules in nodes that may be independent from the current condition and operand to each node. Accordingly, in this example, each node, Node 1, Node 2, Node 3 also include Rule 4 (and its conditions).

FIG. 7B shows another step for compiling decision tree 704 in accordance with at least one of the various embodiments. Using rule set 500 as an example, an application such as, rule compiler 312, may be arranged to generate a decision tree as described herein. Decision tree 704 builds on the steps for generating decision tree 702.

In at least one of the various embodiments, a rule compiler, such as, rule compiler 312 may be arranged to prune decision tree 704 to remove rules from nodes where may be certain to remain un-matched. For example, in at least one of the various embodiments, Rule 4 may be pruned from Node 1 because if Node 1 is reached during execution, Rule 1 will be matched while Rule 4 will not be so Rule 4 may be removed from Node 1. In contrast, in at least one of the various embodiments, in this example, Rule 4 remains associated with Node 2 and Node 3 because during execution, this node may be reached before it is determined if Rule 1 (for Node 1) or Rule 2 (for Node 2) are matched since they have at least one condition in addition to hostname ‘ends-with’ (e.g. for Rule 1 URI starts-with ‘/images’, and for Rule 2 query-string starts-with ‘q=’). Thus, for this example, at Node 2 and Node 3 in decision tree 704 the policy engine is unable to determine if Rule 1 or Rule 2 match the input operand.

FIG. 7C shows another step for compiling decision tree 706 in accordance with at least one of the various embodiments. Using rule set 500 as an example, an application such as, rule compiler 312, may be arranged to generate a decision tree as described herein. Decision tree 706 builds on decision tree 704.

In at least one of the various embodiments, the rule compiler may continue the compilation steps for the next level of nodes. Accordingly, Node 2 is associated with the condition URI starts-with. Like the first operand/condition pair used for the root node, URI may be a string operand and starts-with is a pattern match condition. Thus, in at least one of the various embodiments, the rule compiler may generate a trie based evaluator for Node 2. In at least one of the various embodiments, in this example based on rule set 500, there may be three potential outcomes, matching ‘/images’, matching ‘/videos’, or no match. Accordingly, in at least one of the various embodiments, since there are three potential outcomes, the rule compiler may generate three nodes, such as, for example, Node 5, Node 6, and Node 7. Note, for this example, the three nodes correspond to a single rule in the rule set absent any conditions so they are leaf nodes that corresponding to rule matches.

Likewise, in at least one of the various embodiments, for this example, the remaining node in the decision tree that includes more than one rule may be further reduced by the rule compiler. For example, Node 3 may be reduced to Node 8 which is a leaf node represent a match for Rule 2 and Node 9 which includes Rule 4 and the condition Uri starts-with.

Accordingly, in at least one of the various embodiments, the rule compiler may generate an evaluator for the Node 9, this again, for this example, may be a trie or other string pattern matching based evaluator. In at least one of the various embodiments, since Node 9 may have two potential results, the rule compiler may further reduce Node 9 into Node 6 which matches Rule 4 and Node 7 which corresponds to a non-match of the rule sets. Note, in this example, the rule compiler generated Node 7 earlier, thus a transition from Node 9 may point to Node 7 for the no match result.

Continuing with this example, the rule compiler may further reduce the remaining top level node, Node 4. As shown in FIG. 7C, Node 4 includes Rule 4, operand URI, and condition starts-with. In this example, if URI starts-with ‘/video’ the decision tree may be arranged to transition to Node 6 (a match node) or to Node 7 which is the rule set no-match node.

In at least one of the various embodiments, if each node in the decision tree has been reduced by the rule compiler, the decision tree may be arranged to capture each potential result for corresponding rule set including a no match condition where the operands do not match any conditions. Importantly, in at least one of the various embodiments, rules may be matched without having to evaluate each condition in the rule set. Because, in at least one of the various embodiments, as the first leaf node in the decision is reached, the correct rule may be determined and the corresponding actions may be triggered. For example, in at least one of the various embodiments, Node 1 and Node 4 are the only nodes in decision tree 706 that need to be evaluated if a HTTP request is a pure non-match. For example, for decision tree 706, if the operand hostname is ‘qqq.com’ and the operand URI starts with ‘/script’ only Node 1 and Node 4 need to be evaluated to determine that the request is a no match for the entire rule set.

In at least one of the various embodiments, separate decision trees may be generated for disjunct or disjoint rules/conditions rather than including the disjunct or disjoint conditions in each node of the decision tree. In the example described for decision tree 706, Rule 4 includes a disjunct condition. In at least one of the various embodiments, a separate root node and decision tree may be generated for the disjunct conditions that may be included in the rule set. Accordingly, in at least one of the various embodiments, an application, such as, policy engine 320, may be arranged to execute one or more threads for each decision tree representing the disjunct rules/conditions.

In at least one of the various embodiments, in some cases multiple rules may be matched by the same input operands. In these cases, in at least one of the various embodiments, the determination of which of the multiple rules to trigger may be determined by a policy strategy that may be set and/or defined using configuration information. In at least one of the various embodiments, policy strategies may include, first match, best match, and all match.

In at least one of the various embodiments, the first match policy strategy may enable a policy engine, or other application, employing a rule set decision tree to execute the actions first rule reached. Accordingly, the order of the rules within the rule set may be used for determining which rule within a rule set has higher precedence. For example, if two rules are matched at the same time during execution, the actions for the rule having the higher precedence may be executed and actions of the rule with the lower precedence may be ignored.

In other embodiments, a best match policy strategy may be used to determine which rule may be executed if there are multiple rule matches. In at least one of the various embodiments, best match policy strategy may include defining that different operands and/or condition have higher precedence over others. In at least one of the various embodiments, there may be pre-defined configuration information that may be used for ranking the precedence of the operands and/or conditions that may be include in the rules. The ranking for the various relevant operands and/or conditions may depend on the application. For example, in at least one of the various embodiments, a rule set decision tree used to manage HTTP/OSI Level 7 networking traffic may require different operand/condition precedence ranking than a firewall application that may be monitoring network traffic at OSI Level 4.

Further, in some cases, the policy strategy may indicate that a more precise rule may have precedence over a more general rule. In at least one of the various embodiments, a precision may be determined by the number of operands included in a rule. For example, if two rules are matched, the actions for the rule having the most operands may be executed and the other rules action ignored.

In at least one of the various embodiments, precision may also be determined by the number of conditions and/or the length of the match for a condition with the rule having the more conditions or the longer condition test having the higher precedence. For example, if Rule 5 includes hostname starts-with ‘www’ and Rule 6 includes hostname starts-with ‘www.qqqq.com’, Rule 6 maybe considered the rule with greater precision and thus it may have higher precedence over Rule 5.

Also, in at least one of the various embodiments, a policy strategy may be configured to execute the actions for each rule that matches. In at least one of the various embodiments, in some applications to avoid rules that may include conflicting and/or mutually exclusive actions, the rule compiler may be arranged to include additional safeguards. In at least one of the various embodiments, rules in rule set may be assigned to one or more categories of actions. These categories may be arranged such that the rules in a given category may be limited to actions that may not conflict. For example, in at least one of the various embodiments, a category may be defined such as, cache/caching, in some embodiments, a rule compiler may be arranged to only allow one rule designated as being in the cache category for a rule set.

In at least one of the various embodiments, since decision tree may be represented as state machine or other deterministic finite automaton (DFA) structure, a rule compiler, such as, as rule compiler 312 may be arranged to compress the decision tree into a packed data structure that may comprise contiguous memory minimized for machine word length based on the complexity of the decision tree.

Furthermore, even though the innovations herein may be described in terms of OSI Level 7 (application layer) network monitoring, it is envisaged that in at least one of the various embodiments, a rule compiler may be arranged to generate decision trees for a variety of solutions. Accordingly, in at least one of the various embodiments, the innovations herein may be considered a general solution to generate decision trees from rule sets where the rules include operands, conditions, and action that correspond to the rules.

In at least one of the various embodiments, applications, such as, a policy engine that may be employing a decision tree may locally cache operand values in cache memory in case they may be used with other conditions within a decision tree.

FIG. 7D illustrates a tabular representation of decision tree 708 in accordance with at least one of the various embodiments. In at least one of the various embodiments, decision trees may be arranged as state machines or other deterministic finite automaton (DFA) structures. However, table 710 is presented here for brevity and clarity to describe the operation of decision tree 708.

In this example, each row of table 710 includes information corresponding to a node that was generated by the rule compiler. Column 712 contains the node identifier of a decision tree node. Column 714 contains the operand associated with the node. Column 716 contains the condition/test operation that is associated with the node. Column 718 describes the possible transitions and/or transition points (to one of, another node, a match node, or a no-match node) based on the possible results from evaluating the operand and condition pair. And, column 720 contains the rule (from rule set 500) that are associated with the node.

In at least one of the various embodiments, nodes in a decision tree are arranged such that the first node is associated with the most common operand/condition pair. Accordingly, in this example, the Root node (at row 722) is the entry point to decision tree 708.

In at least one of the various embodiments, testing the most common operand/condition pair enables the concurrent evaluation of highest number of conditions. For example, since rule set 500 includes three Hostname end-with tests (once each in Rule 1, Rule 2, and Rule 4), the rule compiler will generate an evaluator for Hostname ends-with and associate it with the Root node. Further, in this example, a single tie may be generated to test all of the conditions associated with the Root node. (See, FIG. 6).

Column 718 contains a list of nodes the decision tree may transition to, depending on the results of evaluating the operand/condition pair. The results will be one of transitioning to another node, a match (triggering the execution of the actions of the corresponding rule), or a no-match, indicating none of the rules in the rule set matched.

In at least one of the various embodiments, match and no-match nodes may be leaf nodes in the decision tree. Accordingly, in this example, leaf nodes in decision tree 708 correspond with single rule, or the no-match condition. In this example, nodes 1, 5, 6, 7, and 8, are leaf nodes. In particular, nodes 1, 4, 5, and 6 are match nodes that match a single rule and node 7 corresponds to the no-match result. Thus, if the decision tree transitions to one or more leaf nodes, either a rule has been matched or no rules are found to match.

For example, if a request having a Hostname that ends with the value ‘f5.com’ is provided to the decision tree. First, the evaluator associated with the Root node will be evaluated resulting in a transition to node 1. Node 1 is a match node so no further evaluations are needed. Accordingly, in this example, Rule 3 will be matched and its corresponding actions may be triggered.

In another example, if a request includes a Hostname value that ends with the value ‘aaa.com’, again, the evaluator associated with the Root node will be evaluated resulting in a transition to node 3. In this case, the Root node evaluator determined only one of the conditions for Rule 2, the Hostname end-with ‘aaa.com’ condition, so the decision tree is transitioned to another node (node 3) for testing the remaining condition for Rule 2. In this example, if the query-string of the request starts with ‘q=’ the decision tree will transition to node 8, which is match node for Rule 2; otherwise, the decision tree will transition to node 9 for further evaluation.

In at least one of the various embodiments, the arrangement of decision tree 708 as generated by the rule compiler enables four Rules to often be evaluated in less operations than it would take to evaluate each rule one at a time. In comparison, a brute force process may iterate over each rule in order which may require more time and computing resources than employing the optimized decision tree. Also, the rule compiler may generate the decision tree automatically to result in efficient processing no matter what order individual rules are order placed in the rule set. This avoids the necessity of relying on users to manually order the rules in the rule set. Note, while for brevity and clarity this example uses a rule set with four simple rules, in practice rule sets may comprise many rules, many of which that may be more complex than those shown herein.

### Generalized Operations

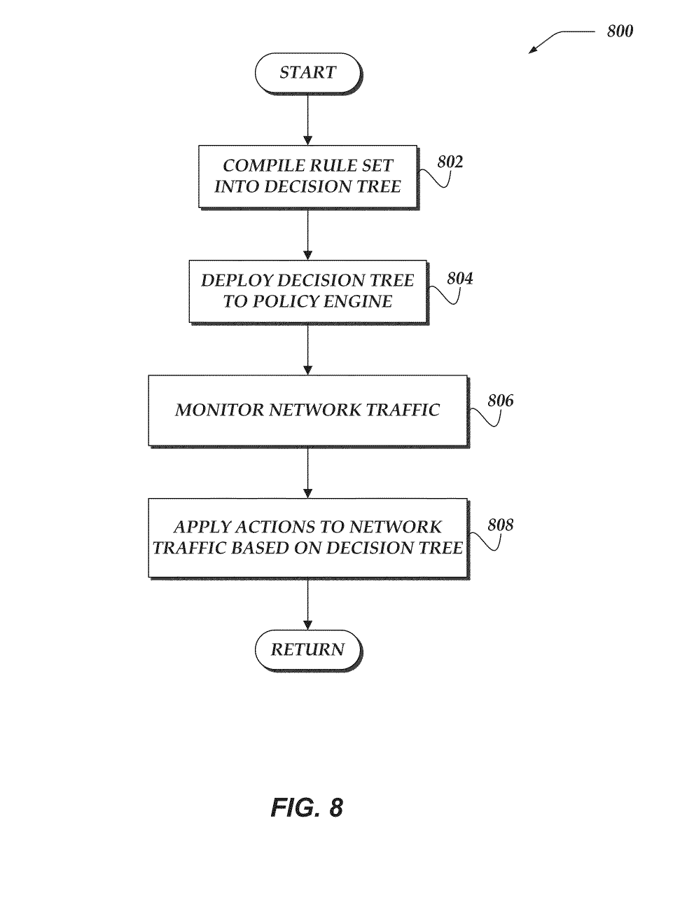

FIGS. 8-11 represent the generalized operations for concurrent evaluation of large rule sets in accordance with at least one of the various embodiments. In at least one of the various embodiments, processes 800, 900, 1000 and 1100 described in conjunction with FIGS. 8-11 may be implemented by and/or executed on a single network computer, such as network computer 300 of FIG. 3. In other embodiments, these processes or portions thereof may be implemented by and/or executed on a plurality of network computers, such as network computer 300 of FIG. 3. However, embodiments are not so limited, and various combinations of network computers, client computers, virtual machines, or the like may be utilized. Further, in at least one of the various embodiments, the processes described in conjunction with FIGS. 8-11 may be operative in traffic management devices, systems, and architectures, such as, those described in conjunction with FIGS. 1-7.

FIG. 8 shows a flowchart of process 800 for concurrent evaluation of rule sets in accordance with at least one of the embodiments. After a start block, at block 802, in at least one of the various embodiments, one or more rule sets may be compiled into a decision tree. In at least one of the various embodiments, a rule set comprising one or more rules may be selected and/or determined for compiling. In at least one of the various embodiments, each rule in a rule set may comprise one or more operand/condition pairs and one or more actions that may be triggered if the rule is matched.

At block 804, in at least one of the various embodiments, the compiled decision tree may be deployed to a policy engine. If the decision tree may be compiled by a rule compiler, such as, rule compiler 312, the decision tree may be provided or otherwise deployed for use. In at least one of the various embodiments, the decision tree may be deployed to a policy engine of a PTMD, such as, policy engine 410.

At block 806, in at least one of the various embodiments, as network traffic may be provided to a PTMD it may monitor the traffic. In at least one of the various embodiments, a PTMD may be enabled to monitor portions of network packets to intercept one or more of the operands that may be included in the decision tree. It is envisaged that the decision tree is not limited to monitoring network traffic. Accordingly, one of ordinary skill in the art will appreciate that decision trees such as those described herein may be employed for evaluating almost any streaming information, or event information in general and are not limited to network traffic and/or being deployed to PTMD's.

At block 808, in at least one of the various embodiments, one or more actions may be taken by the PTMD based on the results determined by the one or more decision trees. As operands and conditions are evaluated one or more rules in the rule set may be matched using the decision trees. Accordingly, in at least one of the various embodiments, the actions that may correspond to the indicated rule or rules may be triggered. Next, in at least one of the various embodiments, control may be returned to a calling process.

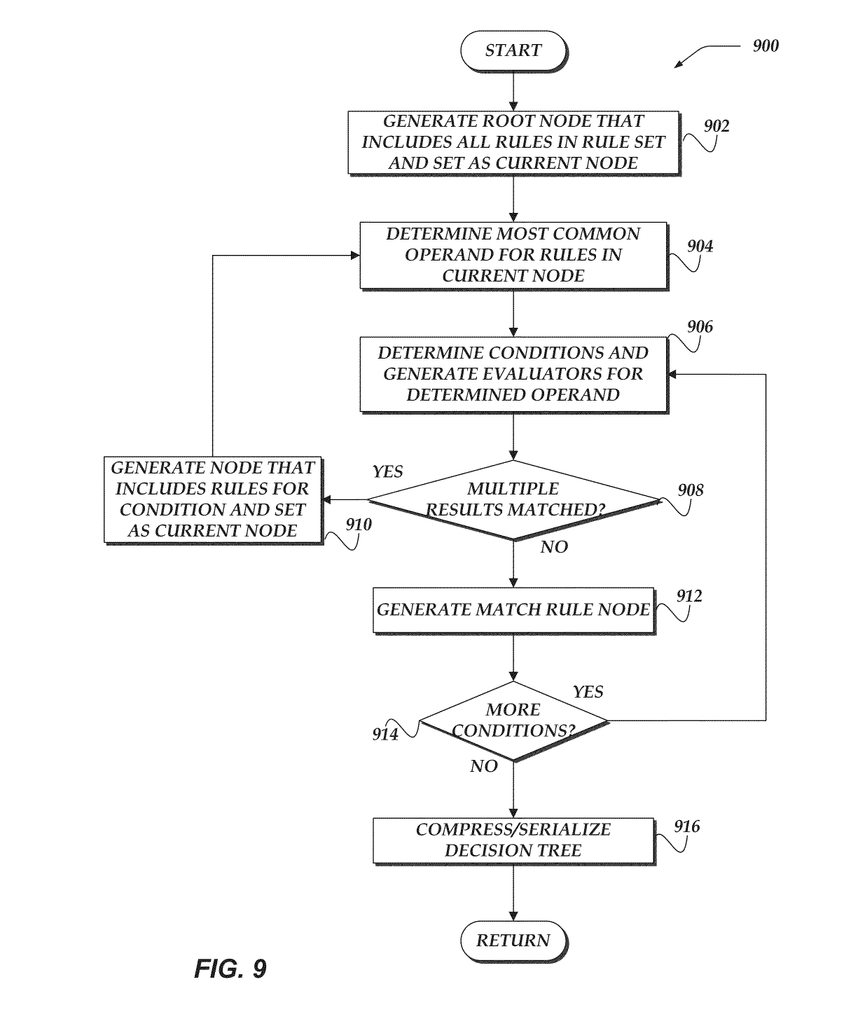

FIG. 9 show a flowchart for process 900 for compiling a decision tree from a rule set in accordance with at least one of the various embodiments. After a start block, at block 902, a root node that includes all or some of the rules in a rule set may be generated and set as the current node. In at least one of the various embodiments, the rule compiler may be arranged to generate a decision tree that may incorporate all of the rules that may comprise a rule set. Accordingly, the first node of the decision tree, the root node, may include all of the rules that comprise the rule set.

In at least one of the various embodiments, if the rule set include disjunct rules or conditions, the rule compiler may be arranged to generate separate root nodes for the disjunct rules and/or conditions. If so, the following compilation steps may be applied to each root node separately.

At block 904, in at least one of the various embodiments, the most common operand for the rules included in the current node may be determined. In at least one of the various embodiments, the rule compiler may be arranged to examine all of the rules in the rule set that may include the most common operand. From these rules, the rule compiler may determine which condition may be used the most. In at least one of the various embodiments, the rule compiler may be determining which condition operator/operation is used most with the most common operand. Note, the actual matching values may be different. For example, if rules in the rule set include conditions for the URI operand, such as ‘URI ends-with abc’, ‘ URI ends-with xyz’, ‘URI ends-with ddd’, ‘ URI starts-with abc’, ‘URI starts-with xyz’, or the like, ends-with may be determined to be the most common condition operator for the URI operand. Accordingly, in this example, an evaluator that may distinguish between strings that end with abc, xyz, and ddd may be generated (e.g., a trie for string matching similar to FIG. 6).

At block 906, in at least one of the various embodiments, the conditions may be determined for the determined operand for the current node. Also, in at least one of the various embodiments, evaluators may be generated that correspond to the determined operand and the determined conditions.

In at least one of the various embodiments, the particular evaluator that may be generated may vary depending on the type of condition operation that may correspond to the node. In at least one of the various embodiments, the rule compiler may be arranged to generate evaluators that may evaluate the determined condition for all of the rules in one pass. For example, if the rule set includes ten rules having a ‘URI starts-with’ operand/condition pairs a string matching trie may be generated that may evaluate the condition for each of the ten rules in one pass. Likewise, in at least one of the various embodiments, if multiple rules include ‘URI equals’ operand/condition pairs, a different kind of evaluator, such as, lookup table or hash table may be generated.

At decision block 908, in at least one of the various embodiments, if one or more of generated evaluators include transitions and/or results that correspond with at least one rule and at least one condition, the node may be expanded further, so control may flow to block 910; otherwise, control may flow to block 912.

In at least one of the various embodiments, evaluators may include results that resolve the condition being tested but they may not fully resolve which rule in the rule set may be matched. In at least one of the various embodiments, rules may include multiple conditions that may need to be met for the rule to be matched. Accordingly, in at least one of the various embodiments, additional nodes may be added to decision tree to resolve the remaining conditions.

In at least one of the various embodiments, if there are two or more rules associated with one or more transition points, the rule compiler may take further actions, such as, generating another node that includes the two or more rules that are associated with transition points. And, in at least one of the various embodiments, the rule compiler may generate another evaluator that corresponds to another operand and another condition that may be associated with the two or more rules. In contrast, in at least one of the various embodiments, if the at least one transition point corresponds to a single rule absent any condition, a rule compiler may generate a match node for the single rule.

At block 910, in at least one of the various embodiments, since the node being processed corresponds to more than one potential outcome or result, one or more nodes may be generated for each condition/operand pair and added to the decision tree. From block 910, control may loop back to block 904.

At block 912, in at least one of the various embodiments, since one of the potential results of the current node corresponds to a rule match, a match rule node may be generated and added to the decision tree. In at least one of the various embodiments, a match rule node corresponds a rule that has all of its conditions met.

At decision block 914, in at least one of the various embodiments, if more conditions may be associated with the current node, control may loop back to block 906; otherwise, control may flow to block 916.

At block 916, in at least one of the various embodiments, the rule compiler may be arranged to compress and/or serialize the decision tree into a compact form. In at least one of the various embodiments, since the decision tree may be represented using a state machine, DFA, or the like, the rule compiler may be arranged to employ one or more well-known techniques for compacting, compressing, and/or packing the decision tree into a compact form. Next, in at least one of the various embodiments, control may be returned to a calling process.

In at least one of the various embodiments, nodes may include meta-data, such as, indexes or pointers to reference the rules, rather than including all of the rules in the node data structure. Likewise, in at least one of the various embodiments, the rule compiler may be arranged to generate nodes such that the evaluators and or portions of the evaluators may be referenced directly or indirectly using meta-data included in the node. However, in some embodiments, evaluators may be included in the compact representation of the decision tree.

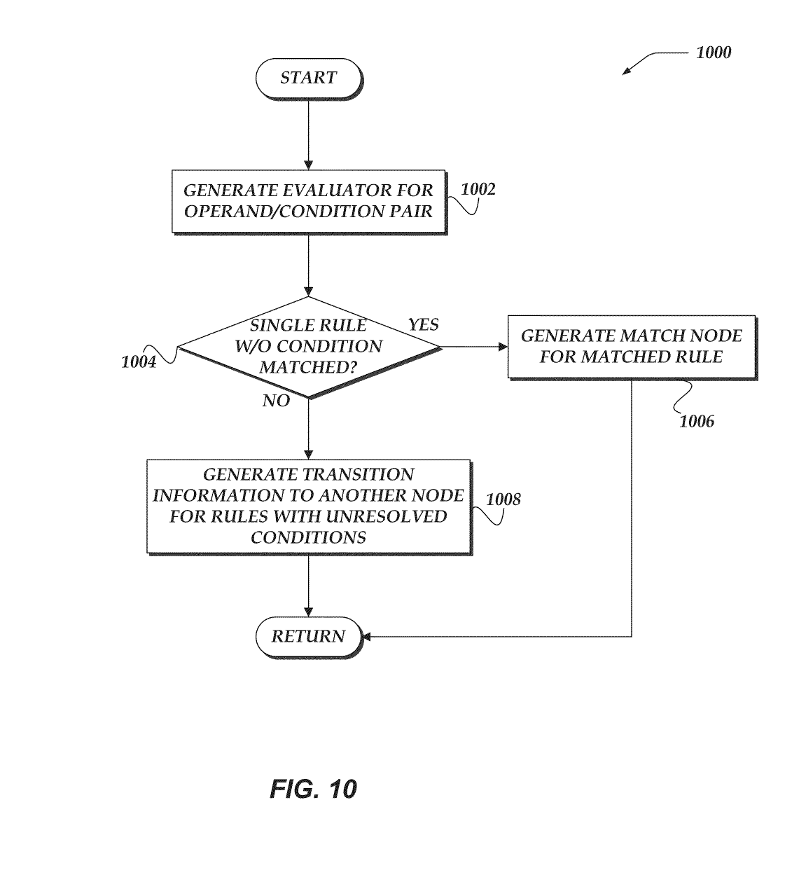

FIG. 10 shows a flowchart for process 1000 for compiling portions of a rule set in accordance with at least one of the various embodiments. After a start block, at block 1002, in at least one of the various embodiments, an evaluator for the operand and condition pair may be generated. In at least one of the various embodiments, the particular form or type of the evaluator may be determined based on the type of operand and/or condition. For example, in at least one of the various embodiments, string based pattern match conditions, such as, starts-with, ends-with, or the like, may be tested using a tie (e.g., sometimes known as a prefix tree) for testing for string matches. In at least one of the various embodiments, if the condition comprises an ‘equals’ test, a lookup table or hash table may be generated to test for the condition.

In at least one of the various embodiments, the rule compiler may generate the evaluator after scanning and/or examining all of the conditions that may be included in the relevant rules.

At decision block 1004, in at least one of the various embodiments, if a single rule may have the potential to be matched, control may flow to block 1006; otherwise, control may flow to block 1008.

For example, if a rule includes a single condition such as ‘hostname equals search.server.com’ the matching transition may resolve to a match rule node since no more conditions would need to be tested. Thus, control may flow to block 1006. Continuing with the example, if the same rule includes another condition such as ‘URI starts-with /data’ control would flow to block 1008 so a transition that points to another node may be generated to handle the remaining condition.

At block 1006, in at least one of the various embodiments, a rule match node may be generated for the matched rule. In at least one of the various embodiments, a rule match node may be generated if the result in the evaluator (for a particular condition) fully resolves to a rule match.

At block 1008, in at least one of the various embodiments, transition information, such as an index or pointer, that points to another node may be generated at the evaluator. In at least one of the various embodiments, the transition information may point to another node that may resolve the remaining conditions for one or more of the rules. Next, control may be returned to a calling process.

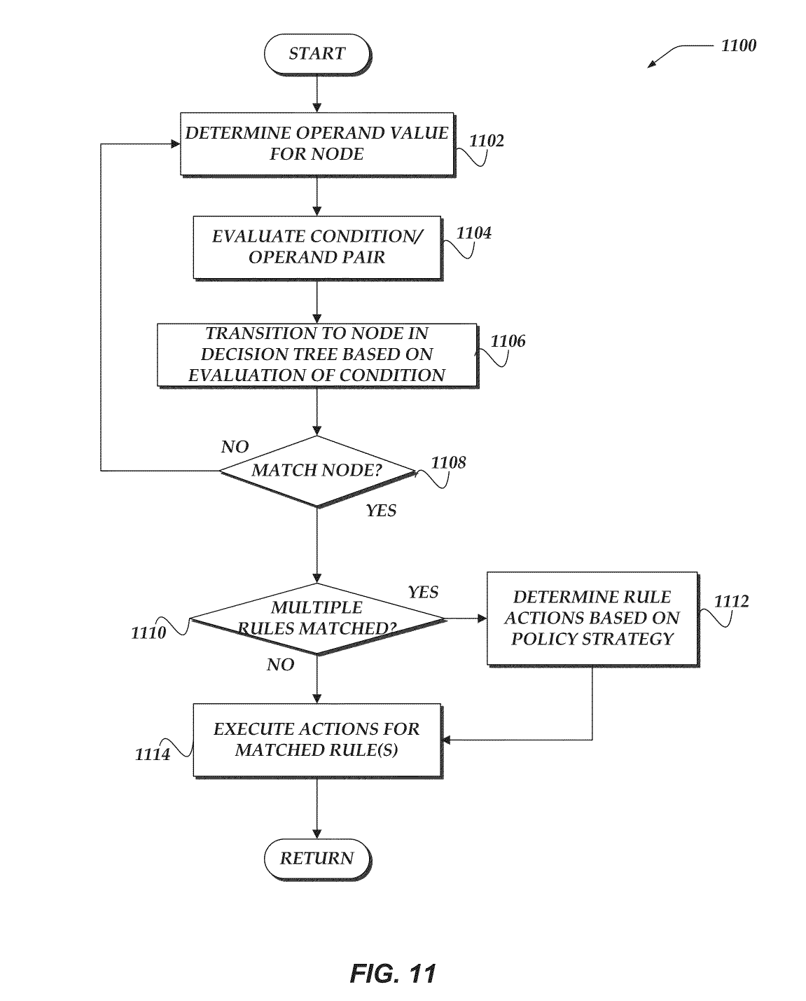

FIG. 11 shows a flowchart for process 11 for the executing concurrent evaluations of rule sets in accordance with at least one of the various embodiments. After a start block, at block 1102, in at least one of the various embodiments, the value of the operand at the current node may be determined. In at least one of the various embodiments, the operand may be determined using information that may be included in the node of the decision tree that is being currently processed. In at least one of the various embodiments, operands may be indicated by an identifier that may be included in the node, such as, an index. In at least one of the various embodiments, the operand identifier may reference a map, or other data structure that includes additional information about the operand, such as, how to retrieve its value, its current value, cache location, cache age, human readable name, precedence information, or the like.

At block 1104, in at least one of the various embodiments, the condition corresponding the node may be evaluated for the current value of the operand. In at least one of the various embodiments, information included in the node may indicate which evaluator to use for evaluating the operand/condition pair.

At block 1106, in at least one of the various embodiments, the process may transition to another node based on the evaluation of the operand/condition pair for the current node. As described above, evaluators may include transition information that corresponds to each potential result that may occur.

At decision block 1108, in at least one of the various embodiments, if the node being transition to is a leaf mode indicating that a match node, control may flow to decision block 1110; otherwise, in at least one of the various embodiments, control may loop back to block 1102.

At decision block 1110, in at least one of the various embodiments, if multiple rules may be matched, control may flow to block 1112; otherwise, control may flow to block 1112.

At block 1112, in at least one of the various embodiments, since the decision tree is resolving to match more than one rule, a policy strategy may be employed for determining the actions that may be triggered. In at least one of the various embodiments, policy strategies may include, first match, best match, all match, and so on, as discussed above. Accordingly, in at least one of the various embodiments, depending on the current policy strategy, actions corresponding to one or more of the matched rules may be determined for execution.

At block 1114, in at least one of the various embodiments, the actions corresponding the matched rule may be executed. In at least one of the various embodiments, if multiple rules were matched, the actions determined in block 1112 may be executed. Next, control may be returned to a calling process.

It will be understood that figures, and combinations of actions in the flowchart-like illustrations, can be implemented by computer program instructions. These program instructions may be provided to a processor to produce a machine, such that the instructions executing on the processor create a means for implementing the actions specified in the flowchart blocks. The computer program instructions may be executed by a processor to cause a series of operational actions to be performed by the processor to produce a computer implemented process for implementing the actions specified in the flowchart block or blocks. These program instructions may be stored on some type of machine readable storage media, such as processor readable non-transitive storage media, or the like.

What is claimed as new and desired to be protected by Letters Patent of the United States is:

1. A method for managing communication over a network with a traffic management device that includes one or more hardware processors, where each step of the method is performed by the one or more hardware processors, comprising:
determining a most common operand that is included in one or more rules, wherein the one or more rules are included in a rule set;
determining one or more conditions that correspond to the most common operand;
generating one or more evaluators that correspond to the most common operand and the one or more conditions, wherein the one or more evaluators include one or more transition points;
when there are two or more rules of the rule set associated with the one or more transition points, performing further actions, including:
generating a node that includes the two or more rules;
adding the node to a decision tree;
generating another evaluator that corresponds to another operand and another condition that are associated with the two or more rules; and
when the one or more transition points correspond to a single rule that is unassociated with any condition, generating a match node for the single rule, wherein the match node is added to the decision tree; and
deploying the decision tree for execution by a policy engine.

2. The method of claim 1, further comprising, serializing the decision tree into a compact form before deploying it for execution by the policy engine.

3. The method of claim 1, further comprising, generating one or more root nodes that include the one or more rule and setting the one or more root nodes as a current node in the decision tree.

4. The method of claim 1, wherein generating the one or more evaluator, further comprises, generating one or more tries for testing the one or more conditions, wherein the one or more conditions include one or more string patterns.

5. The method of claim 1, wherein generating the one or more evaluators, further comprises, generating one or more hash tables to test the one or more conditions, wherein the one or more conditions include one or more equivalency test.

6. The method of claim 1, wherein execution by the policy engine, further comprises, determining one or more match nodes and executing one or more actions that correspond to the one or more final match nodes.

7. The method of claim 1, wherein execution by the policy engine, further comprises, determining one or more actions to execute based in part on a policy strategy.

8. A network computer for managing communication over a network, comprising:
a transceiver that communicates over the network;
a memory that stores at least instructions;
a processor device that executes instructions that perform actions, including:
determining a most common operand that is included in one or more rules, wherein the one or more rules are included in a rule set;
determining one or more conditions that correspond to the most common operand;
generating one or more evaluators that correspond to the most common operand and the one or more conditions, wherein the one or more evaluators include one or more transition points;
when there are two or more rules of the rule set associated with the one or more transition points, performing further actions, including:
generating a node that includes the two or more rules;
adding the node to a decision tree;
generating another evaluator that corresponds to another operand and another condition that are associated with the two or more rules; and
when the one or more transition points correspond to a single rule that is unassociated with any condition, generating a match node for the single rule, wherein the match node is added to the decision tree; and
deploying the decision tree for execution by a policy engine.

9. The network computer of claim 8, further comprising, the processor device executes instructions that perform actions, including, serializing the decision tree into a compact form before deploying it for execution by the policy engine.

10. The network computer of claim 8, further comprising, the processor device executes instructions that perform actions, including, generating one or more root nodes that include the one or more rule and setting the one or more root nodes as a current node in the decision tree.

11. The network computer of claim 8, wherein generating the at least one evaluator, further comprises, generating one or more tries for testing the one or more conditions, wherein the one or more conditions include one or more string patterns.

12. The network computer of claim 8, wherein generating the one or more evaluators, further comprises, generating one or more hash tables to test the one or more conditions, wherein the one or more conditions include one or more equivalency test.

13. The network computer of claim 8, wherein execution by the policy engine, further comprises, determining one or more match nodes and executing one or more actions that correspond to the one or more match nodes.

14. The network computer of claim 8, wherein execution by the policy engine, further comprises, determining one or more actions to execute based in part on a policy strategy.

15. A system for managing communication over a network, comprising:
a network computer, including:
a transceiver that communicates over the network;
a memory that stores at least instructions;
a processor device that executes instructions that perform actions, including:
determining a most common operand that is included in one or more rules, wherein the one or more rules are included in a rule set;
determining one or more conditions that correspond to the most common operand;
generating one or more evaluators that correspond to the most common operand and the one or more conditions, wherein the one or more evaluators include one or more transition points;
when there are two or more rules of the rule set associated with the one or more transition points, performing further actions, including:
generating a node that includes the two or more rules;
adding the node to a decision tree;
generating another evaluator that corresponds to another operand and another condition that are associated with the two or more rules; and
when the one or more transition points correspond to a single rule that is unassociated with any condition, generating a match node for the single rule, wherein the match node is added to the decision tree; and
deploying the decision tree for execution by a policy engine; and
a client computer, including:
a transceiver that communicates over the network;
a memory that stores at least instructions;
a processor device that executes instructions that perform actions, including:
generating the rule set that includes the one or more rules.

16. The system of claim 15, further comprising, the processor device of the network computer that executes instructions that perform actions including, serializing the decision tree into a compact form before deploying it for execution by the policy engine.

17. The system of claim 15, further comprising, processor device of the network computer that executes instructions that perform actions including, generating one or more root nodes that include the one or more rule and setting the one or more root nodes as a current node in the decision tree.

18. The system of claim 15, wherein generating the one or more evaluator, further comprises, generating one or more tries for testing the one or more conditions, wherein the one or more conditions include one or more string patterns.

19. The system of claim 15, wherein generating the one or more evaluators, further comprises, generating one or more hash tables to test the one or more conditions, wherein the one or more conditions include one or more equivalency test.

20. The system of claim 15, wherein execution by the policy engine, further comprises, determining one or more match nodes and executing one or more actions that correspond to the one or more match nodes.

21. The system of claim 15, wherein execution by the policy engine, further comprises, determining one or more actions to execute based in part on a policy strategy.

22. A processor readable non-transitory storage media that includes instructions to manage communication over a network using a network computer, wherein the network computer that executes at least a portion of the instructions performs actions, comprising:
determining a most common operand that is included in one or more rules, wherein the one or more rules are included in a rule set;
determining one or more conditions that correspond to the most common operand;
generating one or more evaluators that correspond to the most common operand and the one or more conditions, wherein the one or more evaluators include one or more transition points;
when there are two or more rules of the rule set associated with the one or more transition points, performing further actions, including:
generating a node that includes the two or more rules;
adding the node to a decision tree;
generating another evaluator that corresponds to another operand and another condition that are associated with the two or more rules; and
when the one or more transition points correspond to a single rule that is unassociated with any condition, generating a match node for the single rule, wherein the match node is added to the decision tree; and
deploying the decision tree for execution by a policy engine.

23. The media of claim 22, further comprising, serializing the decision tree into a compact form before deploying it for execution by the policy engine.

24. The media of claim 22, further comprising, generating one or more root nodes that include the one or more rule and setting the one or more root nodes as a current node in the decision tree.

25. The media of claim 22, wherein generating the one or more evaluator, further comprises, generating one or more tries for testing the one or more conditions, wherein the one or more conditions include one or more string patterns.

26. The media of claim 22, wherein generating the one or more evaluators, further comprises, generating one or more hash tables to test the one or more conditions, wherein the one or more conditions include one or more equivalency test.

27. The media of claim 22, wherein execution by the policy engine, further comprises, determining one or more match nodes and executing one or more actions that correspond to the one or more match nodes.

28. The media of claim 22, wherein execution by the policy engine, further comprises, determining one or more actions to execute based in part on a policy strategy.
